(19) United States
(12) Patent Application Publication
(10) Pub. No.: US 2011/0278061 A1
(43) Pub. Date: Nov. 17, 2011

(54) SYSTEM TO ENABLE GLOVED HANDS TO INTERACT WITH ELECTRONIC TOUCHSCREEN DEVICES

(76) Inventor: Brian P. Farnan, Lakewood, OH (US)

(21) Appl. No.: 13/107,032

(22) Filed: May 13, 2011

Related U.S. Application Data
(60) Provisional application No. 61/334,280, filed on May 13, 2010.

(51) Int. Cl. H01R 3/00; A41D 19/02

(52) U.S. Cl. 174/70 R; 2/169

(57) ABSTRACT

An apparatus comprises a distal conductor that can include a first generally planar substrate, an adhesive layer bonded to a first side of the first generally planar substrate, and a electrically conductive contact that is attached to the first generally planar substrate on a second side of the first generally planar substrate; a connector that is electrically coupled to the contact; and a proximal conductor including a second generally planar substrate that is electrically coupled to the connector. Methods of using the apparatus are also provided.

### RELATED APPLICATION

This application claims priority to, and the full benefit of, U.S. Provisional Patent Application No. 61/334,280 entitled “SYSTEM TO ENABLE GLOVED HANDS TO INTERACT WITH ELECTRONIC TOUCHSCREEN DEVICES” and filed on May 13, 2010.

### TECHNICAL FIELD

The devices, methods and systems described below relate generally to the field of clothing and its ability to allow the user interact with certain electronic devices.

### BRIEF DESCRIPTION OF THE DRAWINGS

FIG. 1A is a plan view of an obverse side of the subject device

FIG. 1B is a plan view of a back side of the subject device.

FIG. 2 is a plan view of a hand wearing a glove with two subject devices attached to the tip of the index finger and thumb.

FIG. 3 is a cross section of a glove showing the inside of such glove with the subject device attached to the fingertip.

FIG. 4 is a plan view of a pull needle.

FIG. 5 is a plan view showing a glove with a pull needle being inserted into the inside of glove.

FIG. 6 is a plan view showing a glove with the pull needle pierced through the tip of the index finger of the glove and the subject device.

FIG. 7 is a plan view showing a glove with the pull needle pierced through the tip of the index finger of the glove and the subject device's tail of electrically conductive material threaded through the eye of the pull needle.

FIG. 8 is a plan view showing the subject device mounted on a glove with the electrically conductive material inside the glove attached to the subject devices hanging outside of the glove.

FIG. 9. is a perspective view of a hand holding a touch screen electronic device and a glove with the subject device mounted to the tip of the index finger.

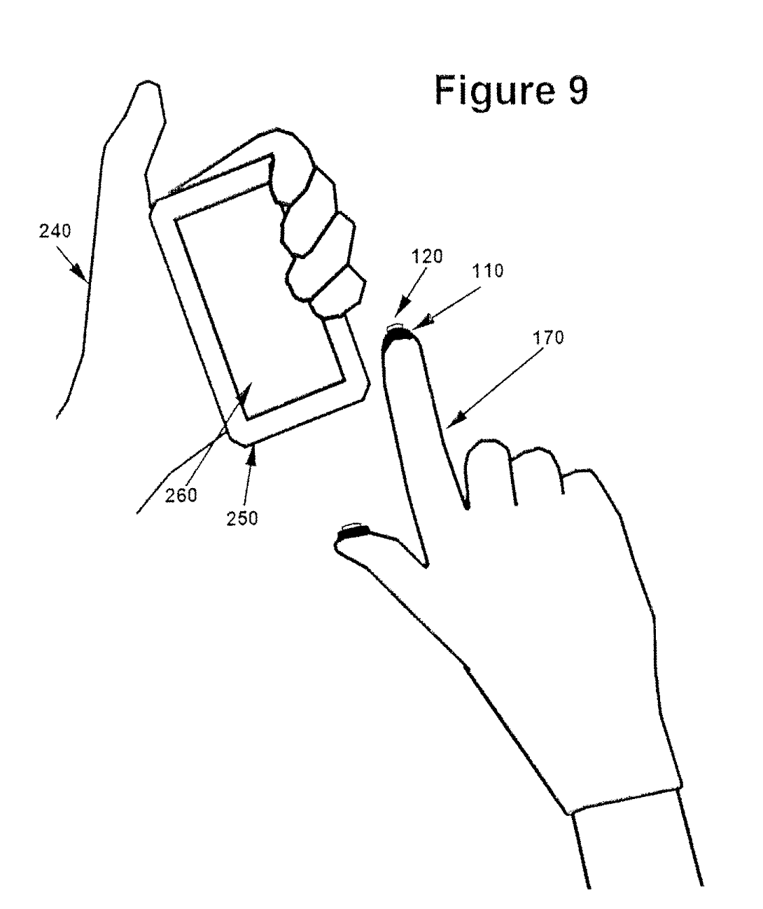

Wearing gloves generally renders the user unable to operate electronic devices that utilize a touch screen and/or other touch-sensitive input feature such as a capacitive screen. The glove prevents the transfer of an electric charge emitted by the user's hand to the touch screen and/or other touch-sensitive input feature device.

### DETAILED DESCRIPTION

The devices, methods, and systems disclosed and described in this document can be used to modify a glove to allow the user to be able to operate electronic devices with touch screens and/or other touch-sensitive input features. For ease of description, the examples included in this document focus on a touch screen device. Those of ordinary skill in this art area will recognize from reading this description that the devices, methods, and systems described can be applied to, or easily modified for use with, other types of equipment. Like reference numerals are intended to refer to the same or similar components.

The examples discussed below are examples only and are provided to assist in the explanation of the systems and methods described. None of the features or components shown in the drawings or discussed below should be taken as mandatory for any specific implementation of any of these systems or methods unless specifically designated as mandatory. For ease of reading and clarity, certain components, modules, or methods, may be described solely in connection with a specific figure. Any failure to specifically describe a combination or subcombination of components should not be understood as an indication that any combination or subcombination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented may be performed in a different order or in parallel

The subject device utilizes conductive materials to carry the electric current emitted by the user's hand to the touch screen and/or other touch-sensitive input feature of the electronic device. The subject device can be installed by the user to allow the user to modify their glove so that it is able to operate electronic devices with touch screens and/or other touch-sensitive input features.

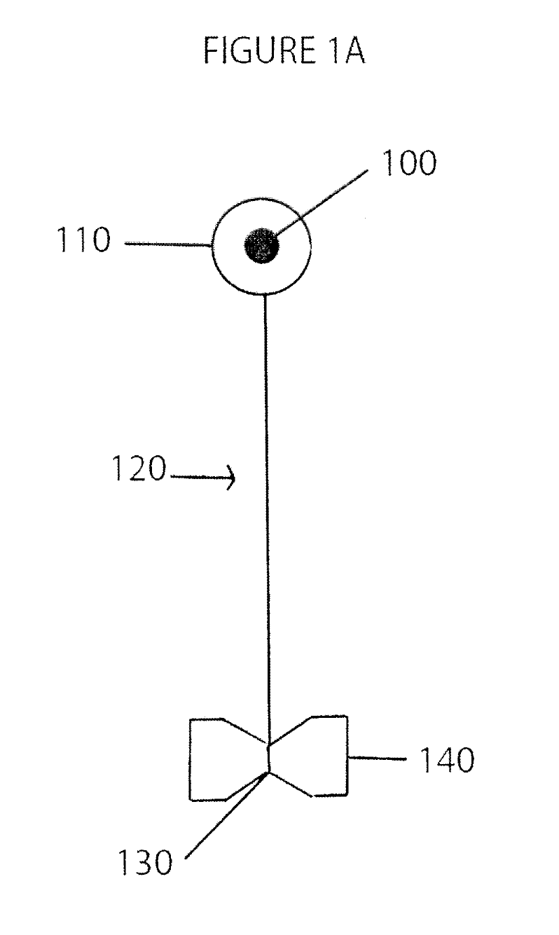

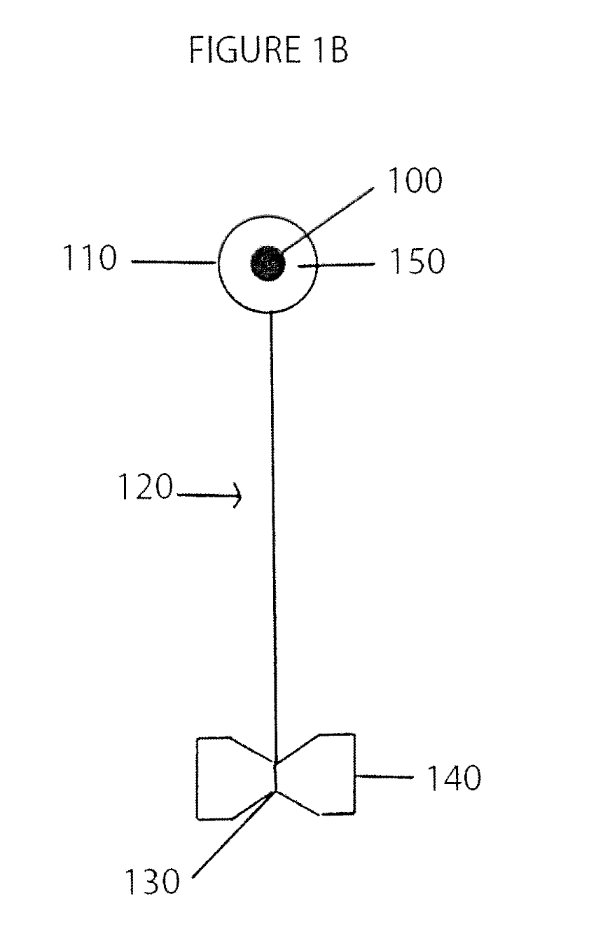

FIG. 1A is a plan view of an obverse side of the subject device. The subject device includes of a distal conductor 110 that is depicted in this example as generally disk-shaped and can be made of fabric with a contact 100 that can be constructed from electrically conductive material stitched into the center of the distal conductor 110. The contact 100 stitched into the center of the distal conductor 110 can be electrically connected to a connector 120. The connector 120 can also be constructed from electrically conductive material or thread The connector 120 can be attached or otherwise electrically coupled or connected with a proximal conductor 140 by tying the connector 120 to the proximal conductor 140. Other appropriate means of connecting the connector 120 to the proximal conductor 140 can be used. Examples of such means of connecting include, but are not limited to, stitching, gluing, bonding, and weaving. The distal conductor 110 can include a substrate that can be made of a variety of suitable materials including cotton, leather, cloth and spandex, metal, plastic, or other suitable materials. The contact 100 and connector 120 can be made of an electrically conductive material, such as silver plated nylon, silver plated yarn, metal wire, carbon-based conductive material, or other suitable conductive material that can carry an electric charge to or from a user's hand. The proximal conductor 140 can be made of a variety of suitable electrically conductive materials including silver coated fabric, carbon coated fabric, copper plated fabric, nickel coated fabric, carbon-based conductive materials, metal, or another suitable conductive material.

FIG. 1B is a plan view of an underside of the subject device. In this example, the connector 120 is shown as electrically attached to the contact 100. Additionally, the connector 120 is shown electrically coupled to the proximal conductor 140 by tying using a knot 130. An adhesive layer 150 is shown on a surface of the substrate of the distal conductor 110. For protection before installation and use in a glove, the adhesive layer 150 can be covered by a removable paper backing (not shown) that can be removed by a user prior to installation of the subject device onto a glove.

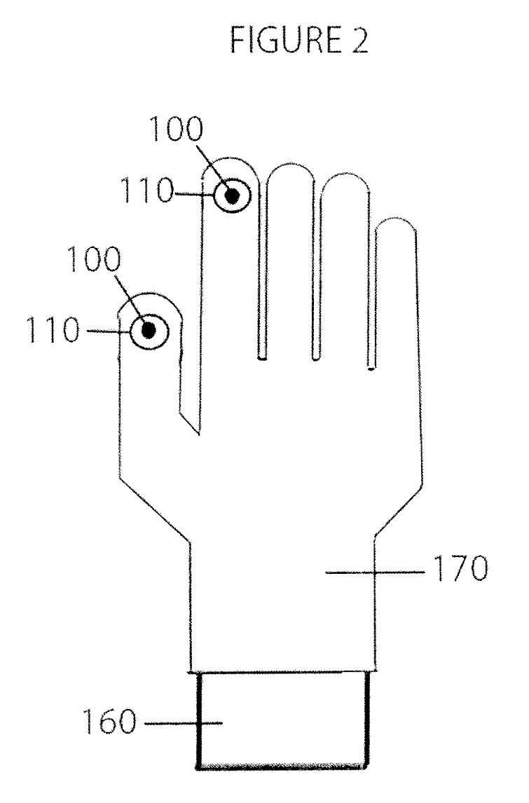

FIG. 2 is a plan view of a hand 160 wearing a glove 170 with two subject devices mounted at distal ends of the index finger and thumb portions of the glove 170. The glove 170 can be made of a variety of suitable materials including fabric, leather, cloth, yarn and spandex or other desired material.

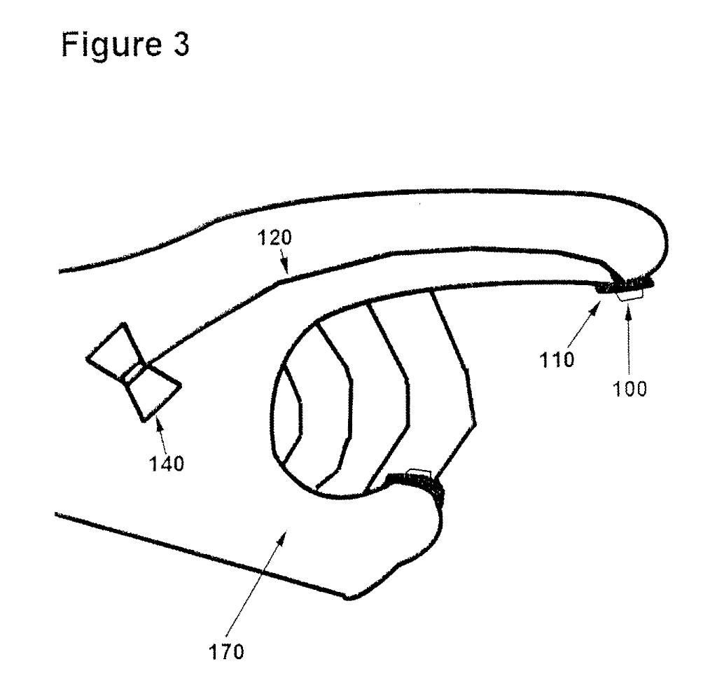

FIG. 3 is a sectional view of the glove 170 with the subject device installed. The distal conductor 110 is mounted to the outside of the glove 170 and affixed in that position by the adhesive layer 150. During installation, the proximal conductor 140 can be positioned inside the glove 170 to contact a user's hand generally at the palm region as shown or can be pushed into the inside of a finger region of the glove 170 by the user (not shown) which can allow for a large surface area to make contact with the user's finger.

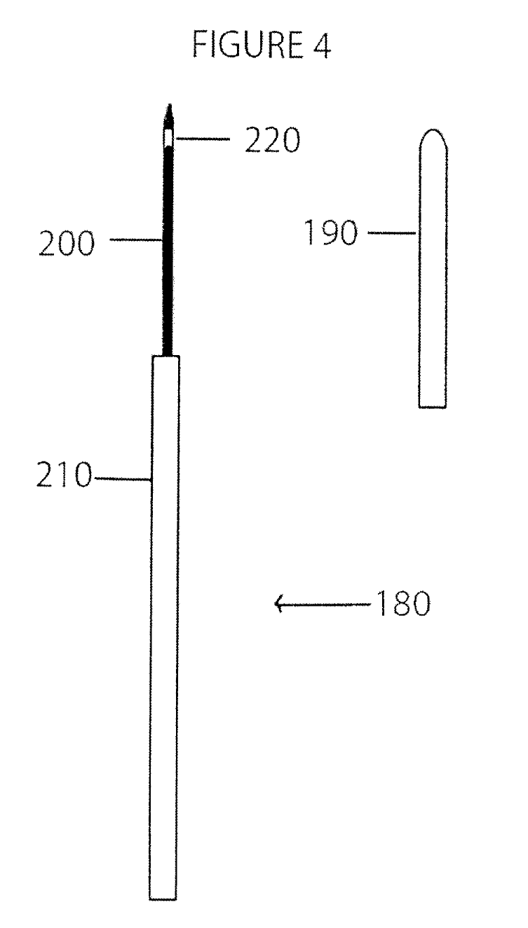

FIG. 4 is a plan view of a pull needle 180 and safety cap 190. The pull needle can include a needle 200 and a handle 210. The needle 200 can include an eye 220 located at the tip of the needle. The safety cap 190 can be placed over the needle 200 and attached to the handle 210. The handle 210 and cap 190 can be made of a variety of suitable materials such as plastic, wood, aluminum or metal.

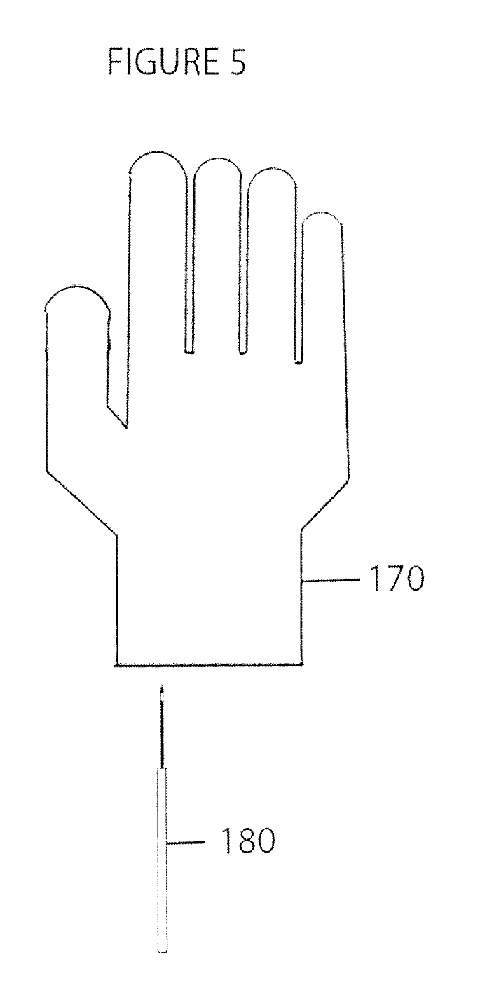

FIG. 5 is a plan view of the glove 170 depicting the pull needle 180 as it is about to be inserted into the interior region of the glove 170. A user can identify a specific desired mounting location for the subject device. The subject device can generally be mounted wherever a user desires but typically will be a tip of one of the fingers of the glove 170, or a knuckle region of one of the fingers of the glove 170. The pull needle 180 can be inserted into the glove 170 so a point of the pull needle 180 is located where a user desires the subject device to be mounted, such as the distal end 230 of the index finger of the glove 170. The user can pierce material of the glove 170 by pushing the pull needle 180 through the material at the desired mounting area.

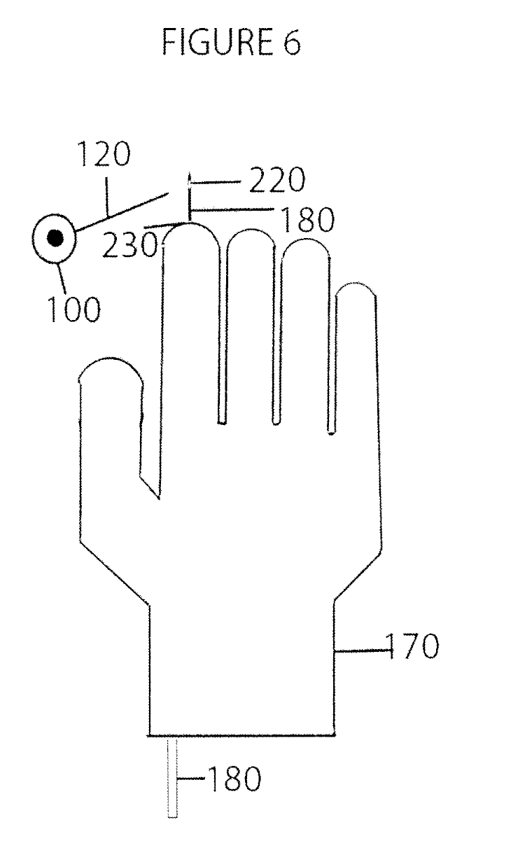

FIG. 6 is a plan view of the glove 170 depicting the pull needle 180 protruding through the material of the glove 170 at the distal end 230 of the index finger of the glove 170. The connector 120 (not shown) can be threaded through the eye 220 of the pull needle 180. Once the pull needle 180 is pushed through the material of the glove 170 at the location where a user desires to mount the subject device, a user can thread the connector 120 through the eye 220 of the pull needle 180.

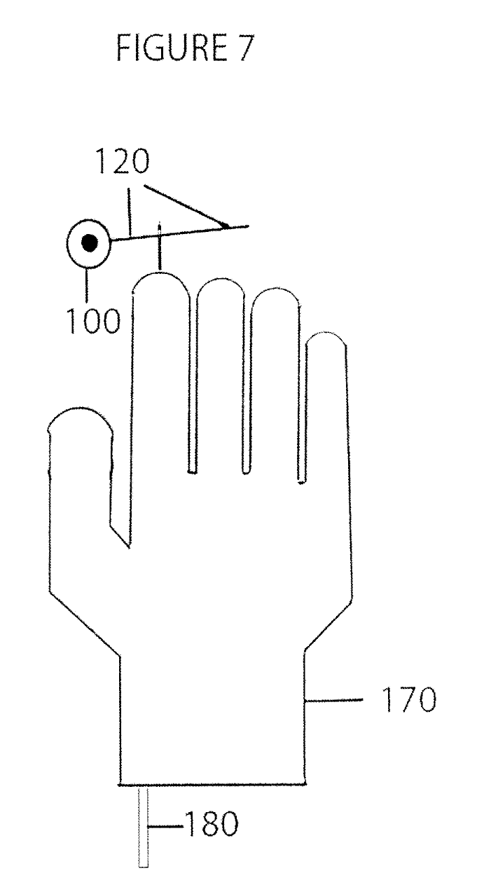

FIG. 7 is a plan view of the glove 170 showing the eye 220 of the pull needle 180 threaded with the connector 120 which is shown attached to the subject device. As the pull needle 180 is removed from the glove 170, the conductor 120 can be positioned inside the glove 170.

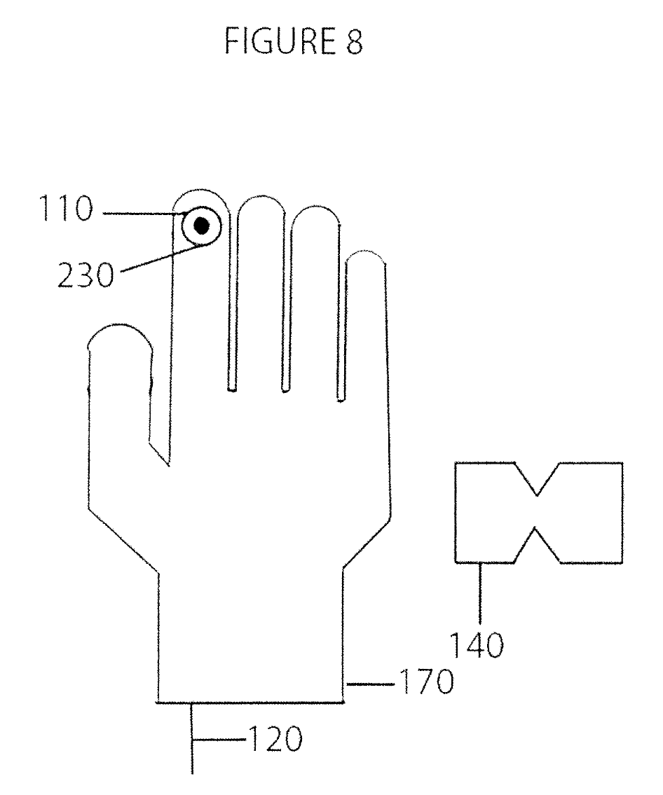

FIG. 8 is a plan view showing the glove 170 where the subject device has been mounted to the distal end 230 of the index finger of the glove 170 and the connector 120 is shown protruding from the proximal end of the glove 170. The connector 120 is connected to the distal conductor 110 which is shown affixed to the glove 170. The connector 120 can be connected to the proximal conductor 140 which can be placed inside the glove 170. When affixing the distal conductor 110 to the glove 170, a user can remove and protective backing (not shown) from the adhesive layer (not shown) of the distal conductor 110 and press the distal conductor 110 against the glove 170 to adhere the distal conductor 110 to the glove 170. This general procedure can be used to permanently mount the distal conductor to the glove 170. Additionally or alternatively, other permanent means of mounting, such as by sewing or stitching, or non-permanent adhesives or other non-permanent mounting means can be used. A user can tie or otherwise affix the connector 120 to the proximal conductor 140. Once the connector 120 is affixed to the proximal conductor 140, such as by tying or another method the user can push the proximal conductor 140 and the attached connector 120 into the inside of the finger of the glove 170 where distal conductor 110 is mounted. The proximal conductor 140 can be used to provide a greater surface area for electrical conduction but can be omitted if desired and the connector 120 can be used without the proximal conductor 140 to provide electrical contact with a user's hand.

FIGURE is plan view of the glove 170 with the subject device mounted to the index finger of the glove 170 and another hand 240 holding an electronic device 250 that has a touch screen 260. The electronic device 250 can include a variety of touch screens 260 such as a capacitive screen or other touch-sensitive input. A user can touch the touch screen 260 with the distal conductor 110. An electrically conductive path provided by the subject device will permit the user's hand to be able to used to activate the touch screen while the user is wearing the glove 170 which may be constructed of a variety of insulating materials.

The above descriptions of various components and methods are intended to illustrate specific examples and describe certain ways of making and using the devices disclosed and described here. These descriptions are neither intended to be nor should be taken as an exhaustive list of the possible ways in which these components can be made and used. A number of modifications, including substitutions of components between or among examples and variations among combinations can be made. Those modifications and variations should be apparent to those of ordinary skill in this area after having read this document.

What is claimed is:

1. An apparatus, comprising:
a distal conductor, including
a first generally planar substrate;
an adhesive layer bonded to a first side of the first generally planar substrate; and
a electrically conductive contact that is attached to the first generally planar substrate on a second side of the first generally planar substrate;
a connector that is electrically coupled to the contact; and
a proximal conductor including a second generally planar substrate that is electrically coupled to the connector.

2. A method, comprising:
passing an electrically conductive connector through an opening in a material of a distal end of a finger portion of a glove;
affixing a distal conductor that is electrically connected to the connector to an exterior region of the distal end of the finger portion of the glove; and
positioning a proximal conductor that is electrically connected to the connector within an interior region of the glove.
